(19) United States
(12) Patent Application Publication
(10) Pub. No.: US 2026/0220651 A1
(43) Pub. Date: Jul. 30, 2026

(54) SIMULATED CUSTOMER SUPPORT TRAINING TICKET GENERATION

(71) Applicant: Zendesk, Inc., San Francisco, CA (US)

(72) Inventors: Divij BHAKOO, Bangalore (IN); Cuneyt CELEBICAN, Manotick (CA); Kelly DANNER, Minneapolis, MN (US); Karun KAMAL, Rajpura (IN); Pranav KOUNDINYA, Bengaluru (IN); Jonathon NEWBY, Indianapolis, IN (US); Alex NIKITIN, Lisbon (PT); Tanay PATEL, Gondia (IN); Fayiz QADRI, Srinagar (IN); Rachna TIWARI, Surat (IN)

(21) Appl. No.: 19/465,909

(22) Filed: Jan. 30, 2026

(30) Foreign Application Priority Data
Jan. 30, 2025 (IN) 202511007978

(51) Int. Cl. G06Q 30/016; G06F 3/0482; G06Q 10/10

(52) U.S. Cl. CPC G06Q 30/016; G06F 3/0482; G06Q 10/10

(57) ABSTRACT

Certain aspects of the disclosure provide a method of generating training tickets for customer support agents. In some aspects, the method may include receiving configuration data defining a training template; generating, by a language model, an initial simulated customer message in accordance with the training template; assigning the initial simulated customer message as a training ticket to a designated customer support agent within a support platform; providing the training ticket to a user interface eliciting a response from the designated customer support agent; receiving an agent response to the initial simulated customer message, wherein the agent response is associated with the designated customer support agent; creating a training conversation based on the designated customer support agent by generating at least one subsequent simulated customer message in response to the agent response; and storing performance data associated with the training conversation and the designated customer support agent.

### CROSS-REFERENCE TO RELATED APPLICATIONS

This Application claims the benefit of and priority to Indian Provisional Patent Application No. 202511007978, filed on Jan. 30, 2025, the entire contents of which are hereby incorporated by reference.

### BACKGROUND

### Field

Aspects of the present disclosure relate to generating training tickets in training support environments by leveraging artificial intelligence (AI) technologies.

### Description of Related Art

Customer support organizations face increasing demands to efficiently train and prepare support agents while maintaining high quality service standards. Traditional approaches to agent training have included shadowing experienced agents, reviewing historical support tickets, and participating in role-playing exercises. These conventional methods often require significant time investments from experienced staff members and may not effectively scale across large support teams. Furthermore, existing training methodologies typically provide limited opportunities for agents to practice handling diverse customer scenarios, despite research in Adult Learning Theory (ALT) demonstrating that hands-on practice and experiential learning can be important for skill development and retention. This limitation is particularly apparent when involving complex product issues or challenging customer interactions. While some organizations have attempted to supplement training with pre-recorded customer interactions or scripted scenarios, such approaches often fail to capture the dynamic nature of real-world support conversations and may not adequately prepare agents for the full range of situations they will encounter in their roles.

### SUMMARY

Certain aspects provide a method of generating training tickets for customer support agents, the method comprising: receiving configuration data defining a training template, the configuration data comprising at least one of: one or more training intents or topics to be addressed, at least one tone of a simulated customer interaction, or an identification of one or more prior customer support tickets or knowledge base documents associated with a training process; generating, by a language model, an initial simulated customer message in accordance with the training template; assigning the initial simulated customer message as a training ticket to a designated customer support agent within a support platform; providing the training ticket to a user interface eliciting a response from the designated customer support agent; receiving an agent response to the initial simulated customer message, wherein the agent response is associated with the designated customer support agent; creating a training conversation based on the designated customer support agent by generating at least one subsequent simulated customer message in response to the agent response; and storing performance data associated with the training conversation and the designated customer support agent.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### DESCRIPTION OF THE DRAWINGS

The appended figures depict certain aspects and are therefore not to be considered limiting of the scope of this disclosure.

FIG. 1 depicts an example system for generating training tickets for a customer support agent in accordance with aspects of the present disclosure.

FIG. 2A and FIG. 2B depict process flows for creating, distributing, and managing training tickets in a customer support environment in accordance with aspects of the present disclosure.

FIG. 3 depicts an example architecture for generating training tickets based on configurable template and parameters in accordance with aspects of the present disclosure.

FIG. 4 depicts an example of how a language model may generate and refine simulated conversations during a training session for customer support agents in accordance with aspects of the present disclosure.

FIGS. 5A-5F depict example user interfaces for creating a training template in a customer support environment in accordance with aspects of the present disclosure.

FIGS. 6A-6B depict example trainer-facing and agent-facing interfaces to simulate customer interactions within a learning-management or support-training environment in accordance with aspects of the present disclosure.

FIG. 7 depicts an example method for generating training tickets for customer support agents in accordance with aspects of the present disclosure.

FIG. 8 depicts an example system for generating training tickets for customer support agents in accordance with aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide apparatuses, methods, processing systems, and computer-readable mediums for generating training tickets in customer support environments by leveraging AI technologies (e.g., generative language models) to automate the creation of realistic and dynamic scenarios that better prepare customer support agents for real-world interactions. In some aspects, such scenarios may serve dual purposes. For example, a scenario may be used to train customer support agents by providing hands-on practice opportunities. Alternatively, or in addition, a scenario may be deployed as an assessment tool to validate agent comprehension and competency following training. A dual-purpose approach can be used in the development of new skills and/or to verify that customer support agents can effectively apply their training in realistic support environments.

Training customer support agents may present technical challenges in creating realistic, dynamic training scenarios that accurately simulate real-world customer interactions. Some training systems often rely on static scripts or role-playing exercises that fail to adapt to agent responses and cannot scale effectively across large support organizations. Additionally, these systems typically operate in isolation from production customer relationship management (CRM) platforms, creating a disconnect between training environments and actual support workflows. This technical problem is compounded by the difficulty of consistently maintaining training scenarios that align with current product knowledge, support policies, and best practices.

In some aspects, disclosed methods and systems address these technical challenges through an innovative architecture that integrates AI technology (e.g., through use of generative language models) with existing CRM platforms to automatically generate and manage dynamic training tickets. In some aspects, a system employs a template creation module that converts administrative parameters into structured training scenarios, which may be processed by a language model to generate context-aware simulated customer messages. A conversation module may coordinate multi-turn interactions between the simulated customer and the agent trainee, while a knowledge base integration module may generate scenarios that incorporate current support documentation and policies. In some aspects, a configuration management module maintains consistency across training parameters and enables scalable deployment of training scenarios.

In some aspects, the technical solutions described herein provide several advantages over conventional approaches. For example, the integration of language models with CRM platforms enables training to occur within the same environment customer support agents use for actual customer support. In addition, the template-based architecture allows organizations to efficiently create and maintain numerous training scenarios while ensuring consistency across large agent populations. In some aspects, a system's ability to generate dynamic, multi-turn conversations provides more realistic training experiences that adapt to customer support agent responses, improving the quality of training outcomes. In some aspects, an automated integration of knowledge base content may enable training scenarios to remain current with product updates and policy changes without requiring manual intervention. In some aspects, a configuration management capability enables organizations to scale their training programs while maintaining control over scenario parameters and performance metrics.

### Example System for Generating Training Tickets

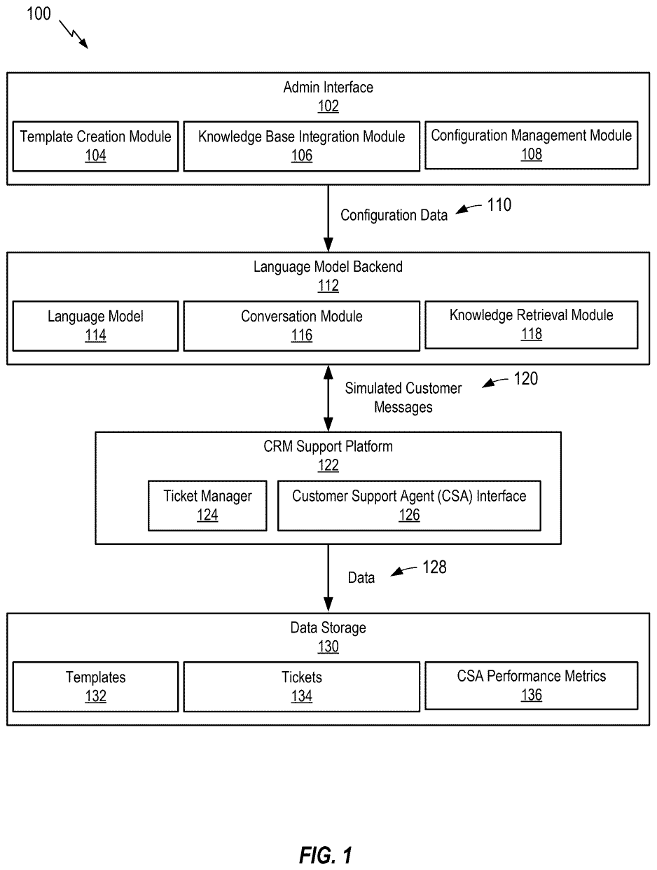

FIG. 1 depicts an example system 100 for generating training tickets for a customer support agent. In some aspects, the system 100 may be implemented using one or more computing platforms that communicate via one or more network connections. In some aspects, one or more modules or components within system 100 can be distributed across multiple servers, or they can reside on a single server hardware. The arrangement shown in FIG. 1 is provided by way of illustration, and other configurations may be used.

In some aspects, system 100 may be configured to facilitate the creation of simulated customer messages and the assignment of such messages to customer support agents as training tickets. In some aspects, the system 100 may include various data stores, user interfaces, and server processes that generate one or more realistic conversation flows. In some aspects, the system 100 may interact with existing customer support platforms and may permit an administrator or trainer to introduce training scenarios that reflect real-world customer interactions.

In some aspects, as depicted in FIG. 1, the system 100 includes an admin interface 102. The admin interface 102 includes a template creation module 104, a knowledge base integration module 106, and a configuration management module 108, and may allow administrative users to manage and configure training scenarios. For example, an administrator may interact with the admin interface 102 to specify training parameters, organize relevant knowledge materials, and define how simulated conversations are to be generated. The admin interface 102 may be presented as a web-based dashboard or other software interface, enabling administrators or trainers to input, edit, and/or retrieve training configuration data in a convenient manner.

In some aspects, the template creation module 104 may facilitate the generation and maintenance of training templates. These training templates may specify conversation tones, industry classifications, customer intents, topics to be addressed, scenarios to be emulated, or other aspects that define how simulated customer messages are formed. In some aspects, customer intents may refer to an underlying objective that drives a customer to initiate a support interaction. For example, a customer intent may include, but is not limited to, requesting refund, reporting a technical malfunction, seeking assistance with account access, inquiring about billing discrepancies, requesting product information, or escalating an unresolved issue. In certain aspects, the training templates can be accessed or duplicated (e.g., by administrative users) for different scenarios, thereby enabling generation of multiple scenarios without the need for repetitive setup and configurations that could result in increased delay in generation of training tickets and/or other downstream processes. The template creation module 104 may also store or retrieve information via one or more databases to ensure consistency across different training sessions. For example, when a business creates a training, a skeleton for a training session is built. This involves providing specific scenario(s), tone(s), and/or relevant document(s) (e.g., a document regarding return policy change). In some cases, a training session may be built with multiple tones and/or scenarios for training. Such information may be stored in a data storage or management system (e.g., a database), which ensures that, for example, the scenarios remain consistent for multiple training sessions. If a scenario includes multiple tones, such as polite, angry, and/or rude, the selected tones may be stored in a database and used consistently for multiple training sessions to create a realistic experience (e.g., a realistic customer support experience).

In some aspects, the knowledge base integration module 106 may interface with one or more repositories of support information. The knowledge base integration module 106 may be utilized to retrieve or link relevant policy documents, product details, and/or reference articles to a training template. For example, an administrator may choose an item to include in a simulated scenario (to be provided as part of an input for a language model), thereby providing a language model with context that reflects actual support knowledge. The knowledge base integration module 106 may also harmonize different data formats so that retrieved items can be incorporated smoothly into the simulated interactions. For example, the knowledge base integration module 106 may receive, as input, an item, retrieved from a knowledge base, in a first data format, and covert the item into a second data format that can be incorporated into the simulated interactions. When a business implements a new return policy that requires training for a customer support agent, the business may create a training template that includes links (e.g., uniform resource locators (URLs)) to relevant policy documents, product details, and/or reference articles (e.g., knowledge base). The training template may then be used to create an initial ticket that includes the URLs. The initial ticket allows the customer support agent to review the relevant information before beginning a training session regarding the new return policy.

In some aspects, the configuration management module 108 may monitor the various settings or parameters used within system 100. These settings or parameters may include allowable conversation types, persona definitions, or thresholds for generating multiple training tickets. In some aspects, administrators can adjust such parameters using the admin interface 102. Accordingly, the configuration management module 108 can obtain and distribute these updates to other components of the system 100. In some examples, the configuration management module 108 may merge custom user-defined parameters with system default parameters to generate an overall training configuration, such as to generate configuration data 110.

In some aspects, as depicted in FIG. 1, a language model backend 112 receives configuration data 110 from the admin interface 102. The configuration data 110 may represent a collection of user-defined and system-defined parameters or settings related to training sessions, simulated interactions, or relevant tickets. The configuration data 110 may indicate, for example, which customer intents and/or topics are to be emphasized in training, which customer tones should be modeled, and how many training tickets may be generated. In some aspects, the configuration data 110 may optionally include timeframe parameters for controlling the distribution of generated tickets over time. Configuration data 110 may be stored in one or more data structures accessible to other components within system 100, thereby ensuring consistency and adherence to selected parameters.

In some aspects, as depicted in FIG. 1, the language model backend 112 includes a language model 114, a conversation module 116, and a knowledge retrieval module 118, and may provide the computational functionality that generates simulated customer messages. In some aspects, the language model backend 112 may incorporate one or more machine learning models and/or rule-based engines, and it may operate locally or be accessed via a remote service (e.g., via application programming interface (API) calls). The language model backend 112 can receive configuration data 110 and other inputs to generate one or more text responses that emulate an actual customer's messages. In some aspects, the language model backend 112 may also transform user prompts or templates into a format for processing by the language model 114.

In some aspects, the language model 114 may be included within or closely coupled to the language model backend 112. The language model 114 may be configured to interpret prompts, prior tickets, and/or knowledge base content. In some examples, the language model 114 may generate context-appropriate text, and may incorporate natural language processing techniques to generate messages that resemble actual customer inquiries, complaints, or feedback. Depending on the chosen configuration, the language model 114 may vary a style or tone to cover different training needs (e.g., friendly, upset, confused, etc.).

In some aspects, the conversation module 116 may coordinate and structure the simulated conversations. In some aspects, the conversation module 116 may track the state of the simulated dialog (e.g., whether the customer support agent has replied or whether new system messages are needed). Based on the responses from the language model 114, the conversation module 116 may determine when to prompt the customer support agent again or when to conclude a particular training ticket. Accordingly, the conversation module 116 may provide for multi-turn conversation functionality (e.g., the capability to generate and manage multiple back-and-forth exchanges between the simulated customer and the customer support agent), thereby enabling comprehensive practice and/or training for customer support agents.

The knowledge retrieval module 118 may handle the selection of background materials or context. For example, the knowledge retrieval module 118 may retrieve sections of policy documents, product frequently asked questions (FAQs), or relevant prior ticket content. The knowledge retrieval module 118 may then provide the selected content to the language model 114 so that simulated interactions can reflect actual policies or known solutions. By referencing these sources, the system 100 can provide a realistic and accurate simulation environment for customer support agent training.

As depicted in FIG. 1, simulated customer messages 120 are communicated between the language model backend 112 and a CRM support platform 122, where the CRM support platform 122 includes a ticket manager 124 and a customer support agent (CSA) interface 126. In some aspects, the simulated customer messages 120 may represent automated or machine-generated communications that emulate real customer inquiries, complaints, or feedback. The simulated customer messages 120 may be formed based on conversation templates, configuration data, and/or relevant knowledge base information. In certain aspects, the simulated customer messages 120 may be triggered in a staged manner, allowing a customer support agent to receive multiple follow-up prompts that mimic how a real customer may change tone, topic, or level of detail over time. By varying the content, complexity, or style of simulated customer messages 120, the system 100 may provide a wide range of training scenarios for agents.

In some aspects, the CRM support platform 122 may be any customer relationship management system capable of handling tickets, user inquiries, and agent assignments. The CRM support platform 122 may be integrated with existing enterprise software environments and may use APIs or other data-sharing mechanisms to coordinate with one or more modules depicted in FIG. 1. In one example, the CRM support platform 122 can manage customer records, track agent performance, and store relevant conversation logs, all in conjunction with the training framework described herein.

In some aspects, the ticket manager 124 may be responsible for creating, routing, and updating tickets associated with either real or simulated interactions. When used for training, the ticket manager 124 may differentiate between live customer tickets and the simulated tickets produced by the system 100. The ticket manager 124 may also collect relevant details about each ticket, such as its current status, assigned agent, and any associated metrics or conversation history. In some aspects, the ticket manager 124 may provide agents with a mix of real and simulated tickets by interfacing with the CRM support platform 122.

In some aspects, the customer support agent interface 126 may present front-end functionality that allows customer support agents to handle incoming tickets, compose responses, and update ticket statuses. In a training context, the customer support agent interface 126 may display simulated customer messages 120 alongside CRM workflow elements, enabling customer support agents to practice responding within the same environment they use for real customers. The customer support agent interface 126 may further allow agents to view suggested documentation or to note feedback on their own performance for reflection and later review.

As depicted in FIG. 1, the CRM support platform 122 provides data 128 to a data storage 130. In some aspects, the data 128 may include a range of information that flows between modules in the system 100. In some aspects, the data 128 may include ticket content, agent responses, knowledge base references, and/or configuration parameters. The data 128 may be exchanged in various formats. For example, the data 128 may include structured objects, JSON documents, or database records. In some aspects, the data 128 may be subject to filtering or transformation before being provided to other modules.

As depicted in FIG. 1, the data storage 130 stores templates 132, tickets 134, and customer support agent performance metrics 136. In some aspects, the data storage 130 may be implemented as one or more repositories for persisting information about templates, tickets, and/or agent performance. The data storage 130 can be organized using relational databases, non-relational databases, and/or cloud-based storage services. The data storage 130 may include configuration details that are used in the generation of simulated customer messages 120, as well as the logs that record how customer support agents responded to those messages. In some aspects, data storage 130 may also store aggregated metrics or analytics for later reporting.

In some aspects, the templates 132 may store definitions or objects specifying various parameters for simulated interactions. In some aspects, the templates 132 may include conversation tone, topic, category, and/or references to knowledge base documentation. By maintaining templates 132 in data storage 130, administrators may quickly generate new training tickets that, for example, adhere to a set of predefined guidelines. The templates 132 may be duplicated, edited, or combined to produce multiple scenario variations without the need to recreate fundamental parameters for each training session.

In some aspects, the tickets 134 may include both actual customer support tickets and training tickets. For example, tickets 134 may be marked or tagged to indicate whether they originate from simulated customer messages 120 or from real customers. Accordingly, the system 100 may allow users to filter or search these tickets based on various attributes, such as agent assignment, ticket status, or conversation type. In some aspects, the collection of tickets 134 in data storage 130 can serve as a resource for performance evaluations, trend identification, and refinement of training scenarios.

In some aspects, the system 100 may include a user interface for creating and/or managing auxiliary training tickets that supplement a primary training template. For example, an administrative user may introduce additional conversation parameters, such as, but not limited to, alternate customer personas, varying levels of urgency, or different product-focus scenarios. In some aspects, the additional conversation parameters may extend beyond the initial template's scope. Accordingly, complexity can be introduced incrementally such that customer support agents are exposed to a broader range of simulated challenges. For instance, an administrative user may configure the system 100 to create (e.g., simulated) follow-up tickets where the “customer” escalates an issue and/or references a new piece of knowledge base documentation. Administrators may further preview and refine these auxiliary tickets through a dashboard interface that displays relevant performance metrics (e.g., resolution times, policy adherence) gathered from completed training sessions.

In some aspects, the customer support agent performance metrics 136 may include various data points or analytics related to agent actions during simulated or real-ticket handling. In some aspects, the customer support agent performance metrics 136 may be stored in data storage 130 and may track factors such as response times, resolution rates, or adherence to guidelines embedded within templates 132. By examining customer support agent performance metrics 136, administrators can determine whether agents are improving, for example, in targeted areas of customer support. Accordingly, the customer support agent performance metrics 136 can be used to inform future adjustments to the templates or system configuration parameters.

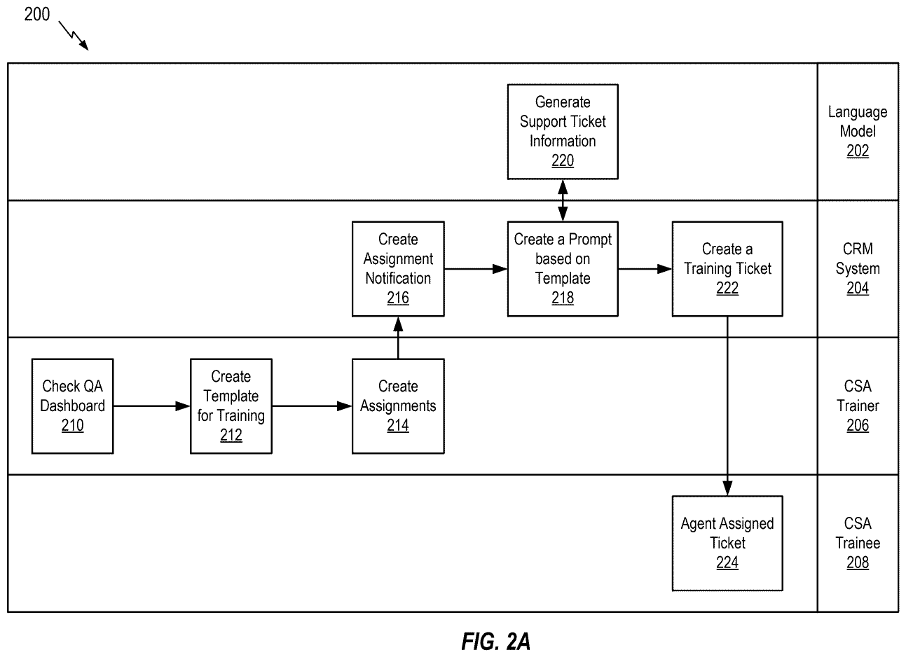

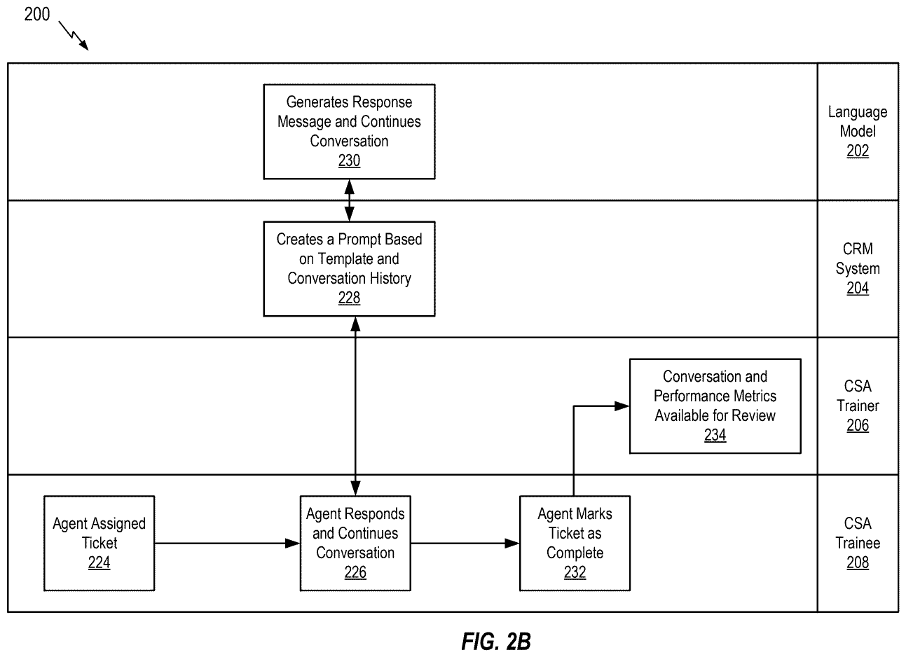

FIG. 2A depicts an illustrative process flow for creating and distributing training tickets in a customer support environment 200 in accordance with aspects of the present disclosure. In some aspects, the customer support environment 200 may include various entities and actions that may be carried out by multiple computing systems, modules, or personnel roles. In certain examples, these entities and actions can be implemented using one or more software platforms communicating over a network.

As depicted, the customer support environment 200 includes a language model 202, a CRM system 204, a customer support agent trainer 206, and a customer support agent trainee 208. The language model 202 may be the same as or similar to the language model 114 of FIG. 1. In some aspects, the language model 202 may represent a computational component configured to generate or refine content related to support tickets. In some aspects, the language model 202 can receive prompts or templates from other modules and produce simulated customer messages or other text-based outputs. The language model 202 may operate using natural language processing techniques, machine learning algorithms, or other suitable approaches to create realistic, context-sensitive statements. In some aspects, the language model 202 may incorporate external data sources or stored conversational histories. In some aspects, the external data sources and/or stored conversational histories may be used to increase the quality and relevance of outputs provided by the language model 202.

In some aspects, the CRM system 204 may be configured to manage the creation, storage, and distribution of support tickets and related customer interactions. Using user interfaces or programmatic interfaces, the CRM system 204 may receive generated prompts from the language model 202 and convert them into training tickets. The CRM system 204 may further coordinate ticket assignments to designated agents, track progress, and handle updates to ticket status. In some examples, the CRM system 204 may also manage archival, retrieval, or reporting functions for both real and simulated tickets.

In some aspects, the customer support agent trainer 206 may be a user or role with responsibilities that include creating training templates, assigning them to agents, and monitoring agent performance. The customer support agent trainer 206 may interact with the CRM system 204 to establish the criteria for training scenarios and to designate particular customer support agents as trainees. Additionally, the customer support agent trainer 206 may review metrics or conversation logs generated during training in order to provide targeted feedback, refine existing templates, or identify areas where additional instruction may be beneficial.

The customer support agent trainee 208 may represent a customer support agent or a group of agents who receive and respond to simulated tickets. In many implementations, the customer support agent trainee 208 interacts with the training tickets through the same or a similar interface used for live customer tickets, allowing for consistent and realistic practice. The customer support agent trainee 208 may compose replies, escalate issues, or mark tickets as complete within the CRM system 204, and performance data can be collected and evaluated by the customer support agent trainer 206.

In some aspects, at 210, a trainer (e.g., customer support agent trainer 206) or other authorized user may access and check a quality assurance (QA) dashboard. In some aspects, this may involve reviewing metrics, conversation transcripts, or past customer support outcomes to identify areas where additional agent training may be advisable. A user interface may be provided through a web application, enabling the trainer to select or filter specific customer intents or skill sets for which training content is to be generated.

In some aspects, at 212, a training template may be created based on insights gained at 210. The training template may define one or more parameters, such as conversation tone, topics, or knowledge base references that should be reflected in simulated scenarios. In some implementations, the training template may be stored in a data repository and assigned a unique identifier, enabling future reuse or duplication without requiring the same parameters to be input repeatedly.

In some aspects, at 214, an assignments-creation process may be initiated whereby a particular customer support agent or agent group is designated to receive new training tickets. In some aspects, this may include specifying the number of training tickets to distribute, scheduling rules, and any constraints on ticket volume or timing. Such assignments may be communicated to other components or modules in the system that handle ticket dispatch.

In some aspects, at 216, an assignment notification may be generated and transmitted to various system entities. In some aspects, this notification can inform a language model backend or a CRM system that certain customer support agents or agent groups have been designated as trainees. In some aspects, the assignment notification 216 may also convey the content of the training template from 212, such that the simulated tickets align with the training objectives.

In some aspects, at 218, the customer support environment 200 may generate a prompt derived from the training template produced at 212. This prompt may include context such as knowledge base references, typical customer concerns, or specific interaction styles. In some aspects, the prompt may be sent to language model 202 to produce realistic customer messages or inquiries. The customer support environment 200 may also apply additional configuration rules to refine or tailor the prompt's parameters.

In some aspects, at 220, the language model 202 or another backend module may utilize the prompt from 218 to create support ticket information consistent with the specified training scenario. In some aspects, this may include drafting initial simulated customer messages, populating metadata fields (such as subject, tags, or urgency), and referencing relevant policies or past ticket data. The generated ticket information may then be returned to CRM system 204 or stored in a designated data structure.

In some aspects, at 222, the CRM system or a related service may receive the support ticket information from 220 and create a training ticket. This training ticket can be distinguished from production tickets (e.g., actual live customer tickets) by means of specialized tags or identifiers. Administrators and trainers may later use these tags to evaluate which tickets are purely educational scenarios and which are customer-driven.

In some aspects, at 224, the newly created training ticket may be assigned to a designated customer support agent or trainee group in accordance with the assignments defined at 214. In some aspects, the customer support agent trainee 208 receives the training ticket through the same interface used for handling real support interactions, permitting a realistic experience. The customer support agent's responses, along with subsequent system-generated messages, may be recorded for later analysis. Performance data or conversation logs can be gathered to refine future training templates or measure agent progress.

FIG. 2B depicts a representative process for managing and completing a training ticket through multiple turns of simulated dialog. The process depicted in FIG. 2B may involve interactions among a language model 202, a CRM system 204, a trainer interface (e.g., for customer support agent trainer 206), and an agent trainee interface (e.g., for customer support agent trainee 208) in the customer support environment 200.

In some aspects, at 226, after reviewing the simulated ticket (e.g., the training ticket assigned at 224 of FIG. 2A), the customer support agent (the customer support agent trainee 208) may generate and send a response. In some aspects, this response may address the topics or issues presented in the simulated customer message of the simulated ticket. The customer support environment 200 may monitor the customer support agent's reply, which may be recorded for subsequent evaluation.

In some aspects, the system component, such as the CRM system 204 working in conjunction with the language model 202, may collect the customer support agent's latest message at 228 and any relevant context from the existing template or knowledge repository. This information may then be compiled into a prompt or structured request. This prompt may incorporate prior user statements, policy-related details, or updated scenario conditions. By referencing both the training template and conversation history, the system can adapt the subsequent message to reflect how the dialog is progressing.

In some aspects, at 230, the language model 202 or an equivalent automated dialog engine uses the prompt from the preceding block (228) to generate the next simulated customer message. This message may escalate, change tone, or provide additional details. The generation process may be repeated as many times as desired, producing realistic, multi-turn interactions that train the agent on various conversational flows.

In some aspects, at 232, once a conversation reaches a logical endpoint, the customer support agent may mark the ticket as complete. In some aspects, this action may remove the training ticket from the customer support agent's open queue and may signal that the simulated scenario has ended. In some aspects, the system may automatically generate a summary of the conversation for reference or future analysis.

In some aspects, upon ticket completion, conversation logs and performance metrics may be accessible to trainers or supervisors at 234. In some aspects, these metrics may include accuracy of the agent's responses, adherence to policies, and overall resolution time. The customer support environment 200 can store and present these metrics in a dashboard or report. Customer support agent trainers 206 may use this data to provide feedback, update training materials, or identify areas where the agent's performance could be improved.

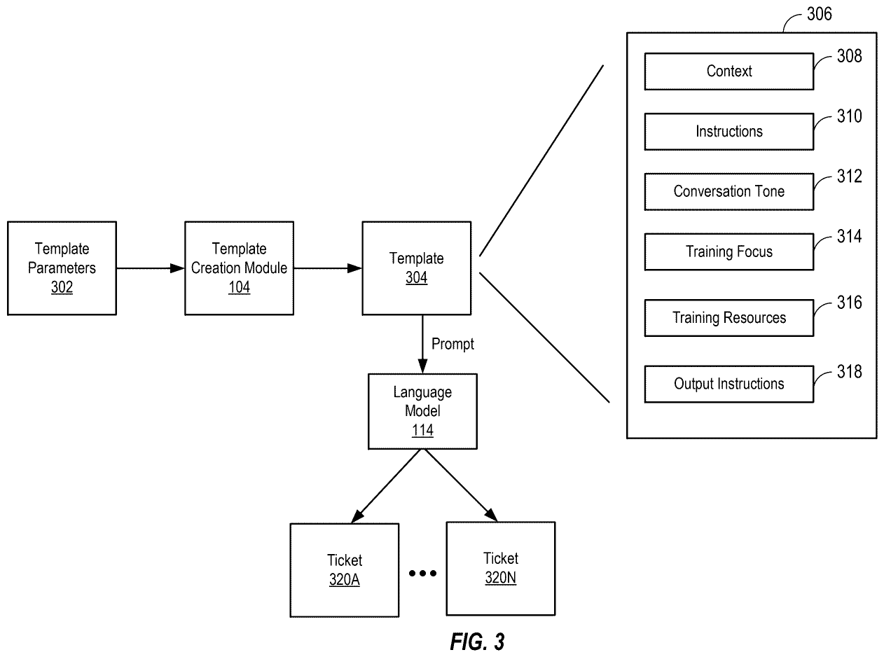

FIG. 3 depicts an example architecture for generating training tickets based on configurable template parameters in accordance with aspects of the present disclosure. In the depicted arrangement, one or more computing systems may receive template parameters 302 and process them through a template creation module 104 to produce a template 304. The template 304 may then be provided to a language model 114, which may then use the instructions and context within the template 304 to create one or more training tickets, such as ticket 320A through ticket 320N.

In some aspects, the template parameters 302 may include user-selected options or (e.g., preconfigured) settings that define various aspects of a simulated training scenario. For example, one or more template parameters 302 may include conversation topics, personas, or any other metadata that may be used to guide how training tickets are generated. The template parameters 302 may be supplied through an administrative interface or retrieved from stored configuration data. In some aspects, the template creation module 104 may receive the template parameters 302 and assemble them into a structured format that can be recognized by other system components. In certain aspects, the template creation module 104 may merge user-defined prompts, resource references, and policy details into a coherent data object. This data object is then stored or passed along for subsequent use in producing simulated ticket content.

In some aspects, the template 304 may be the output of the template creation module 104, providing a set of instructions or guidelines that instruct the language model 114 on generating simulated content. The template 304 may specify conversation flows, response styles, or applicable training focus areas. In some aspects, the template 304 is configured to capture context, instructions, tone preferences, and any other constraints that shape the language model's output.

As depicted in FIG. 3, a data object 306 is associated with the template 304. The data object 306 may include multiple subcomponents or fields, such as context 308, instructions 310, conversation tone 312, training focus 314, training resources 316, and output instructions 318. The data object 306 can be updated or refined to produce different training scenarios. In some aspects, context 308 may reference background information, including customer history or policy references. In some aspects, instructions 310 may define agent guidelines, such as how to respond to sensitive issues. In some aspects, conversation tone 312 may indicate whether the simulated customer interaction should be friendly, angry, inquisitive, or any other style that an administrator wishes to test. In some aspects, training focus 314 may outline targeted skills or metrics, such as empathy, product knowledge, or grammar. Alternatively, or in addition, training focus 314 may specify industry classifications and customer intents to be addressed in the training scenario, allowing for targeted practice in specific business domains with particular customer needs. In some aspects, training resources 316 may provide access points to knowledge bases or policy documents for integration into simulated dialogs. In some aspects, output instructions 318 can address formatting, structure, or any special constraints on how the language model 114 should present its responses.

In some aspects, the language model 114 may receive the template 304 or its underlying data object 306 and generate simulated customer messages or entire conversation threads. The language model 114 may operate using natural language processing to generate text that closely resembles real customer inquiries or feedback. This text may populate newly created tickets and thus facilitate agent training sessions.

Upon receiving prompts and other directives from the template 304, the language model 114 may produce one or more training tickets, depicted in FIG. 3 as ticket 320A through ticket 320N. Each training ticket 320A-N may represent a distinct simulated interaction, having unique conversation content or specific knowledge base references. These training tickets can then be distributed to designated agents for training, stored for future evaluation, or marked for automated analysis and scoring.

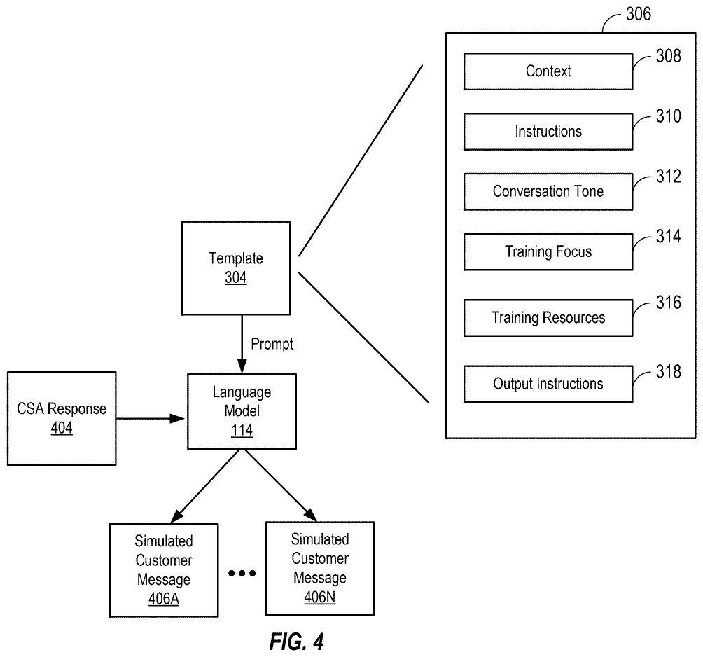

FIG. 4 depicts an example of how a language model may generate and refine simulated conversations during a training session for customer support agents. In some aspects, the template 304, which may include data object 306, guides the language model 114 in producing simulated customer messages, such as simulated customer message 406A-406N. In some aspects, customer support agent responses 404 may be received by the language model 114, allowing for generating multi-turn interactions that reflect realistic customer service exchanges. In some aspects, the template 304 may define the initial scenario or any scenario updates used by the language model 114 to create simulated messages. In some aspects, the template 304 may include parameters such as user persona guidelines, topic constraints, and required policy references and may instruct the language model 114 how to respond to customer support agent response 404.

The customer support agent response 404 may represent a customer support agent's reply to one of the simulated customer messages generated by the language model 114. In some aspects, the customer support agent response 404 can be formed within a ticketing interface that may represent a live customer support environment. The customer support agent response 404 may include clarifying questions, troubleshooting steps, or reference to internal documentation. In some aspects, each customer support agent response 404 can be captured and analyzed to assess customer support agent proficiency, inform performance metrics, or further tailor the ongoing conversation.

In some aspects, the simulated customer messages 406A-406N may be successively generated by the language model 114 in response to one or more customer support agent responses 404. In some aspects, the simulated customer messages 406A-406N may include follow-up questions, requests for additional information, or shifts in conversation tone, thereby emulating the complexity of real-world customer communications. In some aspects, additional messages may be created until the training ticket is marked complete or until a predefined condition (e.g., conversation length or agent performance threshold) is reached. Examples of conversation length may include a number of questions and/or answers, a length of time, etc., and an example of agent performance threshold may include an indication in a customer's message regarding a request having been satisfactorily addressed.

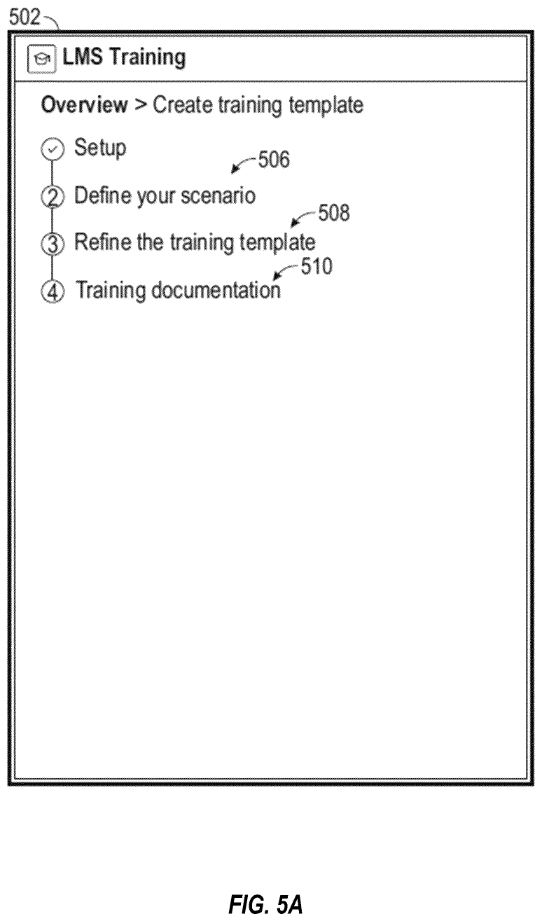

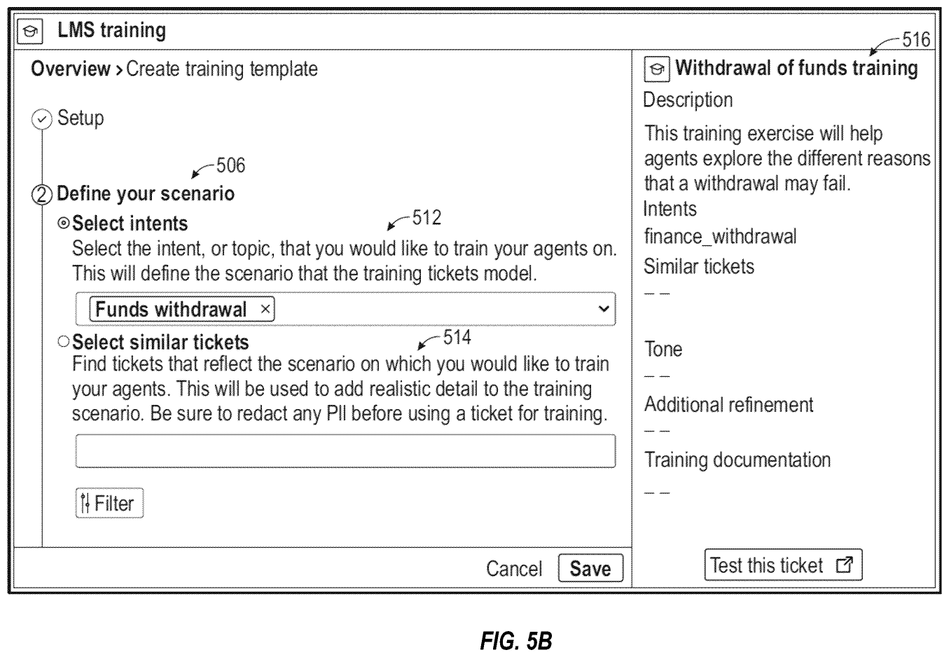

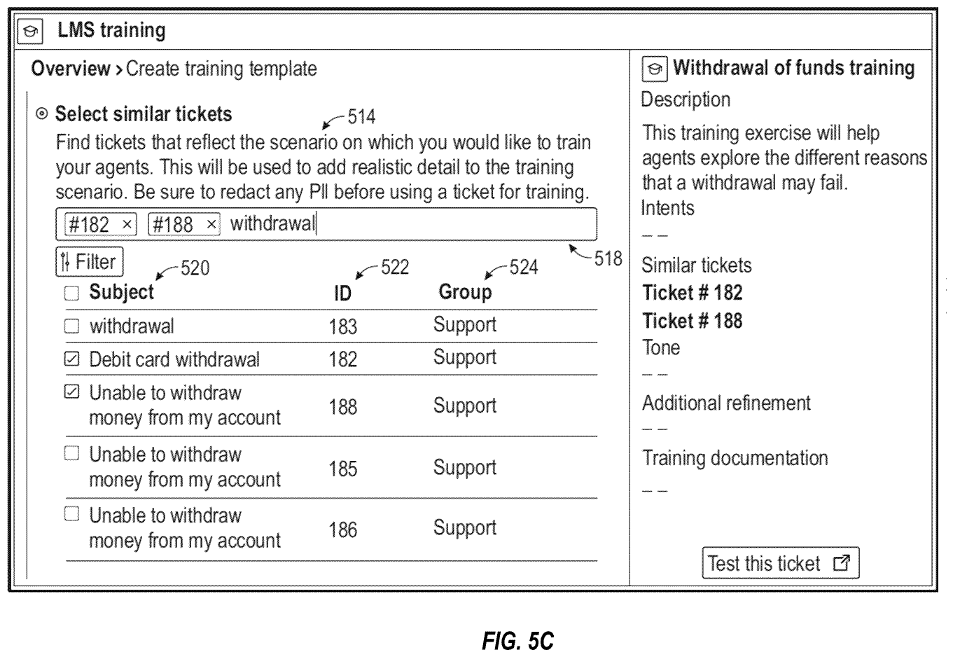

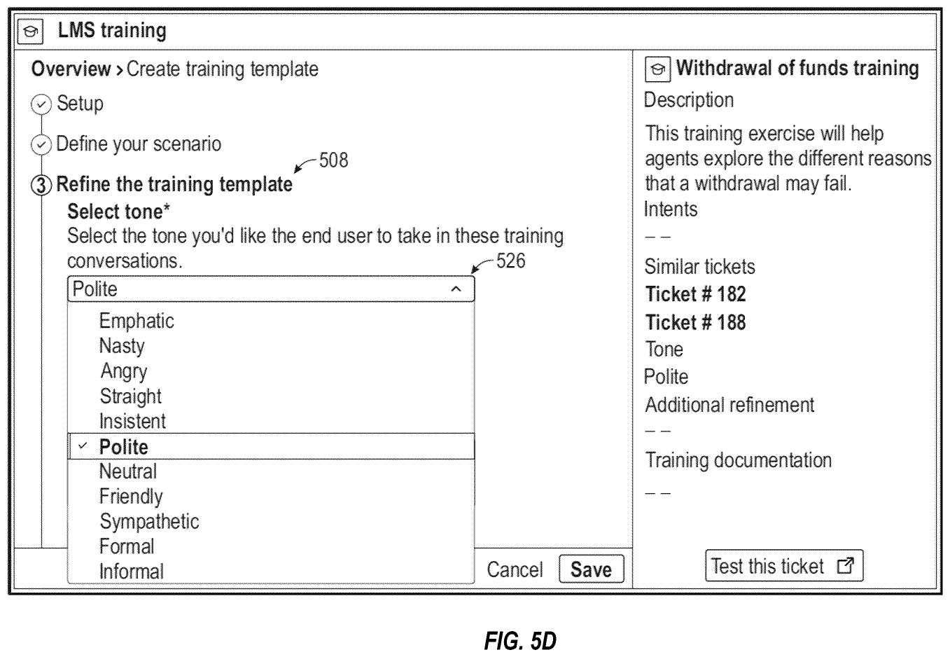

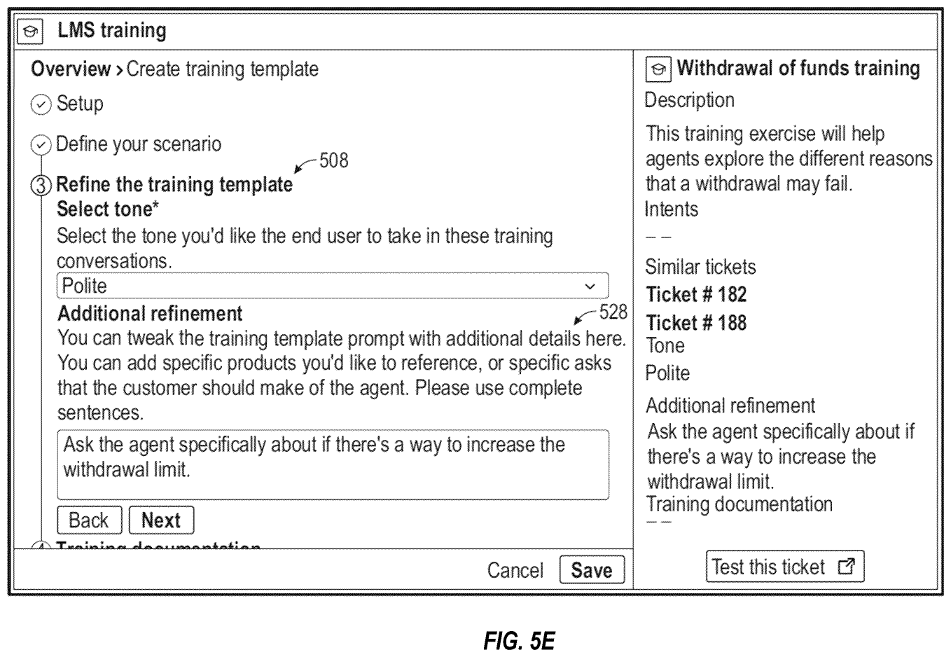

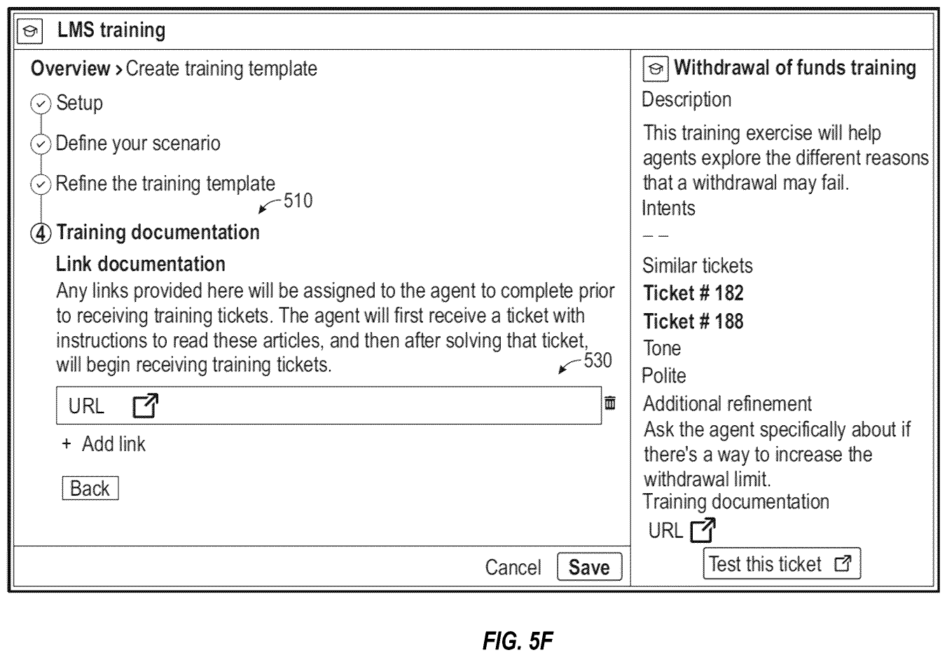

FIG. 5A depicts an example user interface 502 for creating a training template in a customer support environment (e.g., customer support environment 200 of FIG. 2). In some aspects, the user interface 502 may be presented via a web portal, desktop application, mobile application, or another suitable platform, allowing an administrative user to define various parameters related to a simulated training scenario. In some aspects, the user interface 502 includes multiple selectable sections arranged in a hierarchical workflow.

In some aspects, as depicted in FIG. 5A, the user interface 502 includes section 506 configured to enable a user to define a training scenario, section 508 configured to enable a user to refine a training template (e.g., allowing for detailed customization of the template parameters), and section 510 configured to enable a user to incorporate training documentation, if available, into a template configuration.

Each section (e.g., 506, 508, and/or 510) may be separately accessed and modified, allowing for control over the training template creation process. The sections 506, 508, and/or 510 may be visually distinguished through headers, borders, or other graphical elements to facilitate easy navigation. In some aspects, the sections 506, 508, and/or 510 may be presented in a sequential order, guiding the user through a structured template creation process. In some aspects, the user interface 502 may be responsive to user input through various input mechanisms, including but not limited to mouse clicks, touch interactions, keyboard entries, or voice commands. The user interface 502 may provide visual feedback to confirm user actions and validate input parameters throughout the template creation process.

FIG. 5B depicts a second view of the user interface 502, including section 506, for creating a training template in accordance with aspects of the present disclosure. In some aspects, section 506 enables a user to define a scenario. In some aspects, section 506 may provide one or more configuration options for establishing initial parameters of the training template. In some aspects, selection input 512 shown in FIG. 5B may allow a user to input or otherwise select one or more customer intents as an initial parameter of the training template. In some aspects, selection input 514 shown in FIG. 5B may allow a user to find and/or select one or more similar tickets (training or otherwise) that may act as a reference point for the type of customer interaction to be simulated. The one or more similar tickets may help guide the generation of realistic training scenarios by providing a concrete context and/or pattern. For example, the one or more similar tickets may provide a demonstrated terminology, phrasing pattern, or communication style that is to be reflected in a generated training scenario.

In some aspects, the user interface 502 may include a summary component 516 that displays an overview of one or more configured sections of the training ticket during the training ticket creation process. The summary component 516 may display real-time, or near real-time, parameters and setting defined across various configurations sections (e.g., 506, 508, and 510 of FIG. 5A), including but not limited to, selected intents, specified tones, referenced documentation, added refinement instructions, and other template parameters. In some aspects, the summary component 516 may be updated as a user navigates through different configuration sections and modifies one or more training ticket template sections.

FIG. 5C depicts a third view of the user interface 502 for creating a training template in accordance with aspects of the present disclosure. In some aspects, the user interface 502 may include a ticket identification input element 518 (shown in FIG. 5C) that provides search and filtering functionality for locating relevant existing tickets. The ticket identification input element 518 may implement search capabilities, allowing a user to dynamically filter one or more tickets in a training ticket database as search terms and/or ticket identifiers are entered. In some aspects, the ticket identification input element 518 may support advanced search operators, enabling filtering based on multiple criteria such as date ranges, ticket status, or specific keywords.

In some aspects, the user interface 502 may display various ticket-related fields, including: a subject field 520, a ticket identifier field 522, and/or a group field 524. In some aspects the subject field 520 may provide a primary topic or brief description of a ticket's content. The subject field 520 may serve as a quick reference point for identifying relevant training scenarios and may be displayed prominently to facilitate rapid scanning of multiple tickets. In some aspects, the ticket identifier field 522 may display a unique alphanumeric identifier associated with each ticket. Such an identifier may be used for ticket referencing and tracking throughout the training template creation process. In some aspects, the group field 524 may indicate an organizational unit or support team associated with the ticket. The group field 524 may be used to create training templates targeted to specific agent groups or departments.

FIG. 5D depicts a fourth view of the user interface 502 for creating a training template, illustrating a tone selection component in accordance with aspects of the present disclosure. In some aspects, tone selection input element 526 (as shown in FIG. 5D) is implemented as an interactive dropdown box. In some aspects, the tone selection input element 526 enables a user to specify one or more conversational tones that are to characterize the simulated customer interactions within the training scenario. In some aspects, the dropdown box may present a list of tones, which may include, but are not limited to, neutral, professional, frustrated, upset, confused, uncertain, urgent, time-sensitive, friendly, casual, technical, detailed-oriented, demanding, and/or assertive. The tone selection input element 526 may support multiple tone selections, allowing a user to create training scenarios that simulate how a customer tone might evolve throughout an interaction. In some aspects, the dropdown interface may include visual indicators such as checkboxes or toggles to clearly display which tones have been selected. The selected tones may influence how the language model generates simulated customer messages, helping to create more realistic and varied training experiences.

FIG. 5E depicts a fifth view of the user interface 502 for creating a training template, illustrating a refinement instruction component, in accordance with aspects of the present disclosure. In some aspects, refinement instruction input element 528 (shown in FIG. 5E) may be implemented as an expandable text input box. The refinement instruction input element 528 may be configured to allow a user to provide additional, detailed instructions that further customize and refine how the training scenario is to be generated and presented to a trainee. In some aspects, the refinement instruction input element 528 may be configured to accept various types of refinement content, including but not limited to, specific language, terminology preferences, detailed scenario context, background information, custom prompt instructions for a language model, special handling instructions for particular customer situations, additional behavioral guidance for the simulated customer interactions, specific product or service details to be incorporated, business-specific policies or procedures to be used. In some aspects, the refinement instructions entered into the refinement instruction input element 528 may be processed in conjunction with other template parameters to provide guidance to a language model when generating one or more training scenarios.

FIG. 5F depicts a sixth view of the user interface 502 for creating a training template in accordance with aspects of the present disclosure. In some aspects, the user interface 502 includes a documentation linking component implemented through an input field 530 (shown in FIG. 5F) configured to accept URL entries or other documentation identifiers. In some aspects, the input field 530 allows users to incorporate references to external documentation or resources that may be relevant to the training scenario. In some examples, the input field 530 may reference documents, provide the ability of a user to upload a document or text, or reference knowledge base articles, etc.

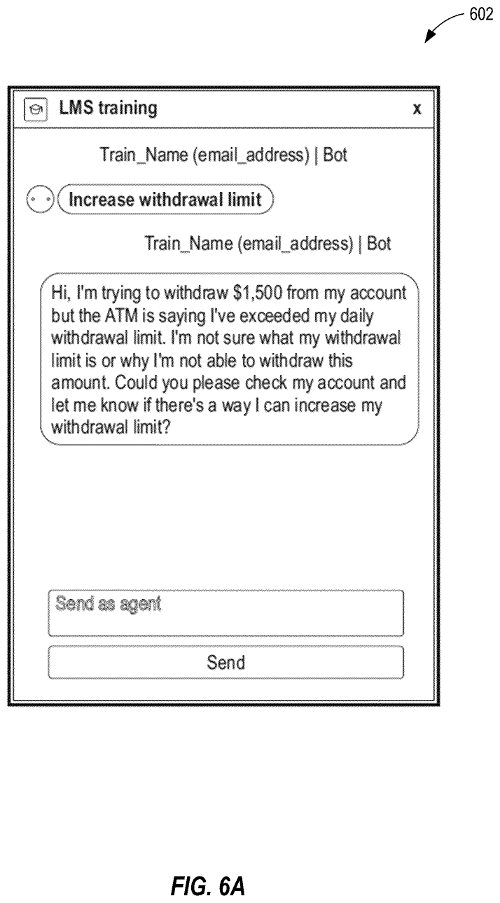

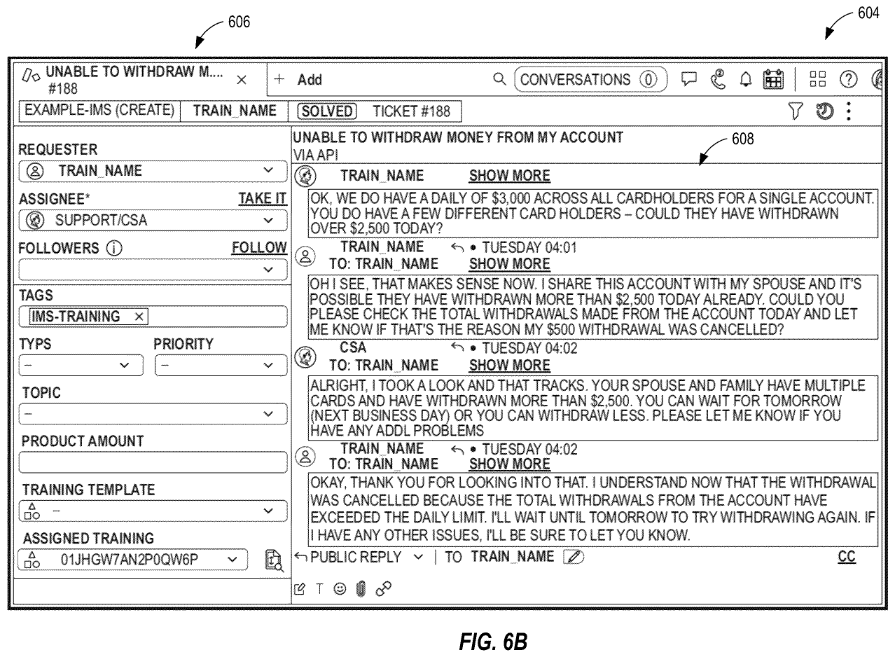

FIG. 6A depicts a trainer-facing testing interface 602 in accordance with aspects of the present disclosure. The trainer-facing testing interface 602 enables users (e.g., trainers) to preview and validate training templates before deployment to customer support agents. In some aspects, the trainer-facing testing interface 602 may display sample outputs generated from the training template (such as shown in FIG. 6A), allowing trainers to assess whether the simulated customer interactions align with intended training objectives.

FIG. 6B depicts an agent-facing interface 604 implemented within a support platform environment in accordance with aspects of the present disclosure. The agent-facing interface 604 may present the training ticket to one or more customer support agents in a format that mirrors the appearance and functionality of real customer support tickets, providing an authentic training experience. In some aspects, the agent-facing interface 604 includes, a ticket header section 606 displaying relevant ticket information; a conversation thread 608 showing the simulated customer message; one or more visual indicators distinguishing training tickets from live customer interactions; and/or integrated access to relevant support tools and resources. Examples of visual indicators distinguishing training tickets from live customer interactions may include a tag (such as in the “TAGS” field depicted in FIG. 6B), an indication in a ticket title (e.g., in the ticket header section 606) such as a keyword included as prefix or suffix to the ticket title, an internal message (e.g., in the conversation thread 608) indicating a ticket is a training ticket, etc.

The trainer-facing testing interface 602 (e.g., of FIG. 6A) and the agent-facing interface 604 (e.g., of FIG. 6B), respectively, provide the ability for trainers to first validate the quality and appropriateness of generated training content before it reaches customer support agents, to help training scenarios meet quality standards and learning objectives, while providing agents with realistic practice opportunities within their familiar support environment.

### Example Method for Generating Training Tickets for Customer Support Agents

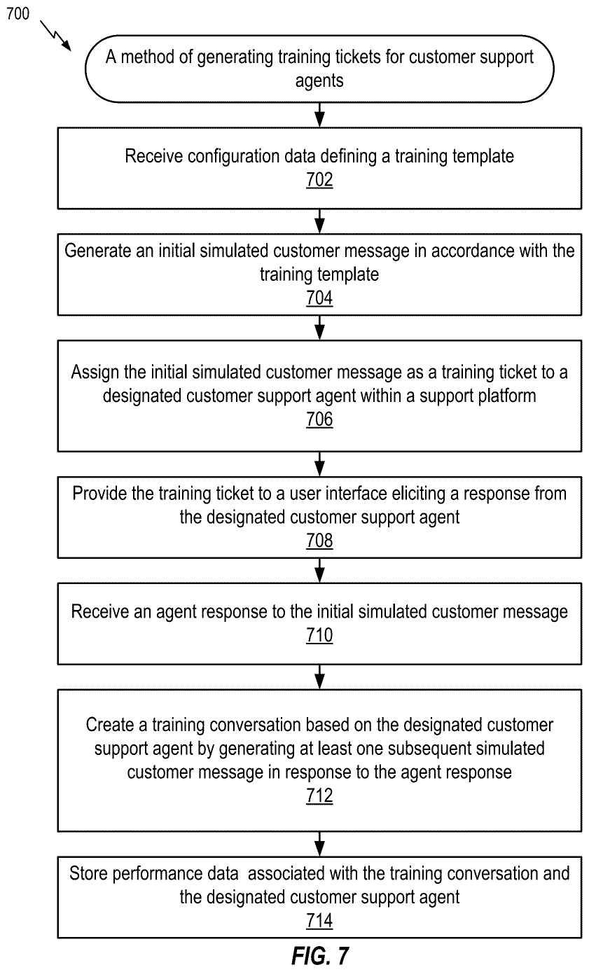

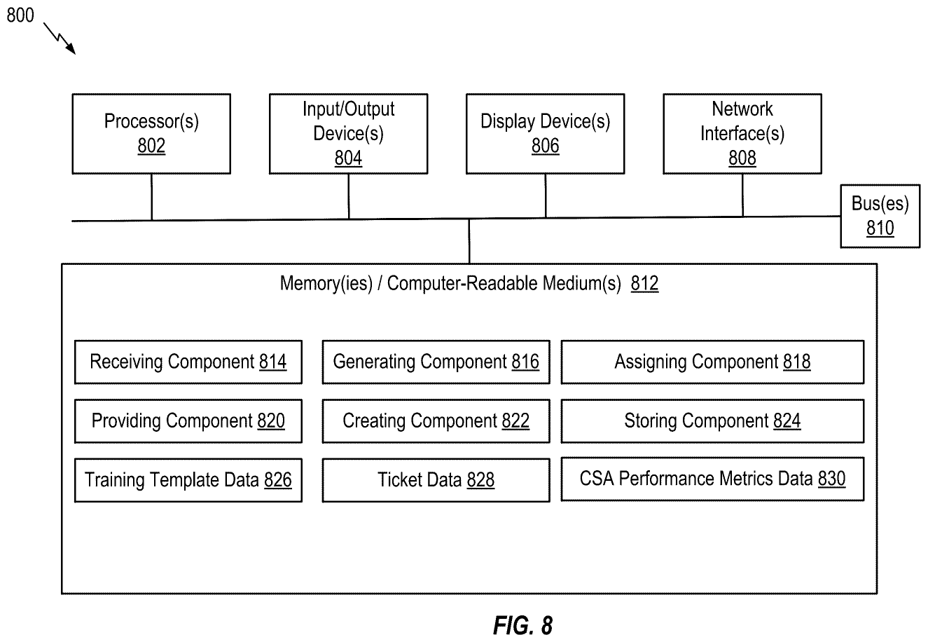

FIG. 7 depicts an example method 700 for generating training tickets in accordance with aspects of the present disclosure. In one aspect, method 700 can be implemented by the processing system 800 of FIG. 8.

Method 700 starts at block 702 with receiving configuration data defining a training template. In some aspects of method 700, the configuration data comprises at least one of: one or more customer intents or topics to be addressed, at least one tone of a simulated customer interaction, or an identification of one or more prior customer support tickets or knowledge base documents associated with a training process. For example, as shown in FIG. 1, an administrator may interact with the admin interface 102 to select or configure parameters for a training template. These parameters can include customer intents, training categories/topics, tones, and references to prior tickets or knowledge base documents. As another example, as described with respect to steps 210 and 212 of FIG. 2A, an administrator may access a QA dashboard, and create or refine a training template. Additionally, FIGS. 5A-5F depict a user interface 502 allowing an administrator to input or modify template parameters like conversation tone of FIG. 5D and customer intents of FIG. 5B.

Method 700 continues to block 704 with generating an initial simulated customer message in accordance with the training template. In some aspects of method 700, a language model may generate the initial simulated customer message. For example, once the training template is established, a system (e.g., the language model backend 112 and the language model 114 of FIG. 1) may generate an initial simulated customer inquiry in accordance with the selected tone, customer intent, and references. As another example, as depicted in FIG. 3, a template 304 and its parameters (e.g., conversation tone 312, training focus 314) are provided to the language model 114 to generate text for tickets 320A-320N. As another example, FIG. 4 illustrates how the language model 114 can generate or refine simulated conversations, where the initial simulated customer message (e.g., 406A) may be the first step in that multi-turn flow.

Method 700 continues to block 706 with assigning the initial simulated customer message as a training ticket to a designated customer support agent within a support platform. For example, after an initial simulated message is created, the system may assign the initial simulated customer message to a designated agent within the CRM support platform 122 of FIG. 1. The ticket manager 124 (e.g., of FIG. 1) may manage the creation and labeling of this “training ticket,” distinguishing it from live support tickets. As another example, FIG. 2A at step 214 and step 222 depicts how a system sets up and assigns these newly generated tickets to specific agents or agent groups for training.

Method 700 continues to block 708 with providing the training ticket to a user interface eliciting a response from the designated customer support agent. For example, the assigned designated customer support agent may see the incoming training ticket in a user interface that closely mirrors actual support workflows. In some aspects, the trainer-facing testing interface 602 and agent-facing interface 604 (of FIG. 6), each displaying how the simulated conversation is presented, may be displayed to the customer service agent. As another example, as described with respect to FIG. 1, the customer support agent interface 126 may provide the customer support agent the ability to receive and/or review training tickets (or other tickets) and compose one or more responses.

Method 700 continues to block 710 with receiving an agent response to the initial simulated customer message. In some aspects of method 700, the agent response is associated with the designated customer support agent. As an example, a trainee may compose a reply to the initial simulated customer message, where the reply may be captured by the same or similar mechanism that handles real support tickets. As another example, as depicted in FIG. 2B at 228, the system collects the agent's message and prepares to generate the next simulated turn of the conversation. FIG. 4 similarly shows how customer support agent responses 404 become inputs to the language model for multi-turn dialog.

Method 700 continues to block 712 with creating a training conversation based on the designated customer support agent by generating at least one subsequent simulated customer message in response to the agent response. As an example, based on the agent's response, the system produces additional simulated customer messages (e.g., simulated messages 406A-406N of FIG. 4). In some aspects, the conversation module 116 (e.g., of FIG. 1) orchestrates multi-turn exchanges, adapting the next simulated response to the agent's latest reply. As another example, FIG. 2B at 230 depicts how the conversation continues, with the language model generating follow-up messages that reflect changing context or new questions. This approach creates a realistic training experience for the agent.

Method 700 continues to block 714 with storing performance data associated with the training conversation and the designated customer support agent. For example, the system tracks and logs how the agent responds—response time, accuracy, escalation decisions, etc. —and stores performance data. In some aspects, FIG. 2B at 232 and 234 depicts how the environment records conversation history and agent performance, enabling QA metrics. As described with respect to FIG. 1, stored performance data (e.g., customer support agent performance metrics 136) is linked to tickets (134) for later review, trending, and training improvements.

In some aspects, receiving the configuration data comprises storing a training template object that includes at least one of: a designated customer persona profile, or a set of conversation parameters.

In some aspects, method 700 further comprises generating multiple training tickets for a plurality of customer support agents based on the training template object.

In some aspects, method 700 further comprises incorporating one or more conversation-specific prompts into the training template, wherein the one or more conversation-specific prompts comprise at least one of: an instruction for the language model to impersonate a type of customer persona, a definition of one or more behavior styles for the simulated customer interaction, or a definition of one or more linguistic styles for the simulated customer interaction.

In some aspects, method 700 further comprises generating one or more auxiliary training tickets based on the training template.

In some aspects, method 700 further comprises presenting, via another user interface, a selectable element for specifying one or more parameters of the training template, wherein the selectable element includes at least one of: a dropdown menu to choose a conversation tone, a text input field for specifying key training topics, or a graphical slider for adjusting a complexity of simulated customer inquiries.

In some aspects, the other user interface comprises a configuration section configured to receive at least one of a prompt modification or a conversation style modification, the configuration section including at least one of: a text editor for adding or modifying language model instructions, a reference link field for associating external knowledge base documents, or a preview pane for displaying potential simulated customer messages prior to deployment.

In some aspects, method 700 further comprises generating at least one auxiliary training ticket through another user interface that: retrieves the training template, prompts an administrative user to select alternate conversation parameters, and triggers the language model to generate additional simulated scenarios reflecting updated parameters.

In some aspects, method 700 further comprises providing a summary view in the other user interface that displays at least one of: a list of primary and auxiliary training tickets, an assigned designated customer support agent for the training ticket, a ticket status, or performance metrics associated with the designated customer support agent.

In some aspects, the other user interface is integrated with the support platform and includes an administrative dashboard for: filtering active training tickets by assigned agent, searching completed tickets by conversation topic or tone, and generating an automated report of agent performance across one or more training sessions.

In some aspects, method 700 provides a technical solution that provides several advantages over conventional approaches. For example, the integration of language models enables customer support agent training to occur within the same environment customer support agents use for actual customer support services. In addition, the template-based architecture allows organizations to efficiently create and maintain numerous training scenarios while ensuring consistency across large agent populations. In some aspects, the system's ability to generate dynamic, multi-turn conversations via method 700 provides realistic training experiences that adapt to customer support agent responses, improving the quality of training outcomes. In some aspects, an automated integration of knowledge base content may enable training scenarios to remain current with product updates and policy changes without requiring manual intervention.

Note that FIG. 7 is just one example of a method, and other methods including fewer, additional, or alternative operations are possible consistent with this disclosure.

### Example Processing System for Generating Training Tickets for Customer Support Agents

FIG. 8 depicts an example processing system 800 configured to perform various aspects described herein, including, for example, method 700 as described above with respect to FIG. 7.

Processing system 800 is generally an example of an electronic device configured to execute computer-executable instructions, such as those derived from compiled computer code, including without limitation personal computers, tablet computers, servers, smart phones, smart devices, wearable devices, augmented and/or virtual reality devices, and others.

In the depicted example, processing system 800 includes one or more processors 802, one or more input/output devices 804, one or more display devices 806, one or more network interfaces 808 through which processing system 800 is connected to one or more networks (e.g., a local network, an intranet, the Internet, or any other group of processing systems communicatively connected to each other), and computer-readable medium 812. In the depicted example, the aforementioned components are coupled by a bus 810, which may generally be configured for data exchange amongst the components. Bus 810 may be representative of multiple buses, while only one is depicted for simplicity.

Processor(s) 802 are generally configured to retrieve and execute instructions stored in one or more memories, including local memories like computer-readable medium 812, as well as remote memories and data stores. Similarly, processor(s) 802 are configured to store application data residing in local memories like the computer-readable medium 812, as well as remote memories and data stores. More generally, bus 810 is configured to transmit programming instructions and application data among the processor(s) 802, display device(s) 806, network interface(s) 808, and/or computer-readable medium 812. In certain aspects, processor(s) 802 are representative of one or more central processing units (CPUs), graphics processing unit (GPUs), tensor processing unit (TPUs), accelerators, and other processing devices.

Input/output device(s) 804 may include any device, mechanism, system, interactive display, and/or various other hardware and software components for communicating information between processing system 800 and a user of processing system 800. For example, input/output device(s) 804 may include input hardware, such as a keyboard, touch screen, button, microphone, speaker, and/or other device for receiving inputs from the user and sending outputs to the user.

Display device(s) 806 may generally include any sort of device configured to display data, information, graphics, user interface elements, and the like to a user. For example, display device(s) 806 may include internal and external displays such as an internal display of a tablet computer or an external display for a server computer or a projector. Display device(s) 806 may further include displays for devices, such as augmented, virtual, and/or extended reality devices. In various aspects, display device(s) 806 may be configured to display a graphical user interface.

Network interface(s) 808 provide processing system 800 with access to external networks and thereby to external processing systems. Network interface(s) 808 can generally be any hardware and/or software capable of transmitting and/or receiving data via a wired or wireless network connection. Accordingly, network interface(s) 808 can include a communication transceiver for sending and/or receiving any wired and/or wireless communication.

Computer-readable medium 812 may be a volatile memory, such as a random access memory (RAM), or a nonvolatile memory, such as nonvolatile random access memory (NVRAM), or the like. In this example, computer-readable medium 812 includes a receiving component 814, a generating component 816, an assigning component 818, a providing component 820, a creating component 822, a storing component 824, training template data 826, ticket data 828, and customer support agent performance metrics data 830.

In certain aspects, the receiving component 814 is configured to perform the receiving operations of block 702. For example, the receiving component 814 may listen for or retrieve template parameters and other configuration information that an administrator may input via, for example, the admin interface 102 of FIG. 1, or the section 506 of the user interface depicted in FIG. 5A. In some aspects, the receiving component 814 can manage inbound data from the agent interface. For example, the receiving component 814 may collect or capture the customer support agent's written reply, which may then be used by the language model 114 or conversation module 116 of FIG. 1 to determine the next step in the simulated conversation flow.

In certain aspects, the generating component 816 is configured to invoke or interface with the language model backend 112 or the language model 114 of FIG. 1, and generate a simulated customer message. In some aspects, the generating component 816 uses the training template data 826 (including tones, topics, or persona parameters) and may also use external knowledge base content (e.g., via the knowledge retrieval module 118 of FIG. 1) to generate an initial simulated message for training.

In certain aspects, the assigning component 818 is configured to route or assign newly created training tickets to the appropriate user or agent. The assigning component 818 may utilize the ticket manager 124 of FIG. 1 and the CRM support platform 122 of FIG. 1 to determine who should receive this training scenario.

In certain aspects, the providing component 820 is configured to manage the delivery of a training ticket to the customer support agent interface 126 of FIG. 1. For instance, as depicted in FIG. 6, the customer support agent may see a simulated “customer” conversation in a user interface that looks similar to their real support environment.

In certain aspects, the creating component 822 is configured to continue or extend the simulated conversation. In some aspects, the creating component 822 may interface with the language model 114 of FIG. 1 and/or the language model 202 described with respect to FIG. 2B to generate additional follow-up messages. This iterative back-and-forth process may be managed by the conversation module 116 of FIG. 1, ensuring the scenario evolves realistically.

In certain aspects, the storing component 824 is configured to write relevant details, including ticket data 828 and customer support agent performance metrics data 830, to a persistent store (e.g., data storage 130 of FIG. 1). Such data can then be surfaced via administrative dashboards or used to refine future training scenarios.

Note that FIG. 8 is just one example of a processing system consistent with aspects described herein, and other processing systems having additional, alternative, or fewer components are possible consistent with this disclosure.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method of generating training tickets for customer support agents, the method comprising:
receiving configuration data defining a training template, the configuration data comprising at least one of:
one or more training intents or topics to be addressed,
at least one tone of a simulated customer interaction, or
an identification of one or more prior customer support tickets or knowledge base documents associated with a training process;
generating, by a language model, an initial simulated customer message in accordance with the training template;
assigning the initial simulated customer message as a training ticket to a designated customer support agent within a support platform;
providing the training ticket to a user interface eliciting a response from the designated customer support agent;
receiving an agent response to the initial simulated customer message, wherein the agent response is associated with the designated customer support agent;
creating a training conversation based on the designated customer support agent by generating at least one subsequent simulated customer message in response to the agent response; and
storing performance data associated with the training conversation and the designated customer support agent.

2. The method of claim 1, wherein receiving the configuration data comprises storing a training template object that includes at least one of:
a designated customer persona profile, or
a set of conversation parameters.

3. The method of claim 2, further comprising generating multiple training tickets for a plurality of customer support agents based on the training template object.

4. The method of claim 1, further comprising:
incorporating one or more conversation-specific prompts into the training template, wherein the one or more conversation-specific prompts comprise at least one of: <an instruction for the language model to impersonate a type of customer persona,
a definition of one or more behavior styles for the simulated customer interaction, or
a definition of one or more linguistic styles for the simulated customer interaction.

5. The method of claim 1, further comprising generating one or more auxiliary training tickets based on the training template.

6. The method of claim 1, further comprising presenting, via another user interface, a selectable element for specifying one or more parameters of the training template, wherein the selectable element includes at least one of:
a dropdown menu to choose a conversation tone,
a text input field for specifying key training topics, or
a graphical slider for adjusting a complexity of simulated customer inquiries.

7. The method of claim 6, wherein the other user interface comprises a configuration section configured to receive at least one of a prompt modification or a conversation style modification, the configuration section including at least one of:
a text editor for adding or modifying language model instructions,
a reference link field for associating external knowledge base documents, or
a preview pane for displaying potential simulated customer messages prior to deployment.

8. The method of claim 1, further comprising generating at least one auxiliary training ticket through another user interface that:
retrieves the training template,
prompts an administrative user to select alternate conversation parameters, and
triggers the language model to generate additional simulated scenarios reflecting updated parameters.

9. The method of claim 8, further comprising providing a summary view in the other user interface that displays at least one of:
a list of primary and auxiliary training tickets,
an assigned designated customer support agent for the training ticket,
a ticket status, or
performance metrics associated with the designated customer support agent.

10. The method of claim 9, wherein the other user interface is integrated with the support platform and includes an administrative dashboard for:
filtering active training tickets by assigned agent,
searching completed tickets by conversation topic or tone, and
generating an automated report of agent performance across one or more training sessions.

11. A processing system, comprising: one or more memories comprising computer-executable instructions; and one or more processors, coupled to the one or more memories, configured to execute the computer-executable instructions and cause the processing system to:
receive configuration data defining a training template, the configuration data comprising at least one of:
one or more training intents or topics to be addressed,
at least one tone of a simulated customer interaction, or
an identification of one or more prior customer support tickets or knowledge base documents associated with a training process;
generate, by a language model, an initial simulated customer message in accordance with the training template;
assign the initial simulated customer message as a training ticket to a designated customer support agent within a support platform;
provide the training ticket to a user interface eliciting a response from the designated customer support agent;
receive an agent response to the initial simulated customer message, wherein the agent response is associated with the designated customer support agent;
create a training conversation based on the designated customer support agent by generating at least one subsequent simulated customer message in response to the agent response; and
store performance data associated with the training conversation and the designated customer support agent.

12. The processing system of claim 11, wherein to cause the processing system to receive the configuration data, the one or more processors are configured to store a training template object that includes at least one of:
a designated customer persona profile, or
a set of conversation parameters.

13. The processing system of claim 12, wherein the one or more processors are further configured to cause the processing system to generate multiple training tickets for a plurality of customer support agents based on the training template object.

14. The processing system of claim 11, wherein the one or more processors are further configured to:
incorporate one or more conversation-specific prompts into the training template,
wherein the one or more conversation-specific prompts comprise at least one of:
an instruction for the language model to impersonate a type of customer persona,
a definition of one or more behavior styles for the simulated customer interaction, or
a definition of one or more linguistic styles for the simulated customer interaction.

15. The processing system of claim 11, wherein the one or more processors are further configured to cause the processing system to generate one or more auxiliary training tickets based on the training template.

16. The processing system of claim 11, wherein the one or more processors are further configured to cause the processing system to present, via another user interface, a selectable element for specifying one or more parameters of the training template, wherein the selectable element includes at least one of:
a dropdown menu to choose a conversation tone,
a text input field for specifying key training topics, or
a graphical slider for adjusting a complexity of simulated customer inquiries.

17. The processing system of claim 16, wherein the other user interface comprises a configuration section configured to receive at least one of a prompt modification or a conversation style modification, the configuration section including at least one of:
a text editor for adding or modifying language model instructions,
a reference link field for associating external knowledge base documents, or
a preview pane for displaying potential simulated customer messages prior to deployment.

18. The processing system of claim 11, wherein the one or more processors are further configured to cause the processing system to generate at least one auxiliary training ticket through another user interface that:
retrieves the training template,
prompts an administrative user to select alternate conversation parameters, and
triggers the language model to generate additional simulated scenarios reflecting updated parameters.

19. The processing system of claim 18, wherein the one or more processors are further configured to cause the processing system to provide a summary view in the other user interface that displays at least one of:
a list of primary and auxiliary training tickets,
an assigned designated customer support agent for the training ticket,
a ticket status, or
performance metrics associated with the designated customer support agent.

20. The processing system of claim 19, wherein the other user interface is integrated with the support platform and includes an administrative dashboard for:
filtering active training tickets by assigned agent,
searching completed tickets by conversation topic or tone, and
generating an automated report of agent performance across one or more training sessions.
